(19) United States
(12) Patent Application Publication
(10) Pub. No.: US 2026/0197658 A1
(43) Pub. Date: Jul. 9, 2026

(54) SYSTEM AND METHOD FOR PROVIDING SECURITY MECHANISM TO UE IN A CORELESS RADIO ACCESS NETWORK

(71) Applicant: JIO PLATFORMS LIMITED, Ahmedabad (IN)

(72) Inventors: Satish JAMADAGNI, Bangalore (IN); Mahesh NAYAKA MYSORE ANNAIAH, Bengaluru (IN); Pradeep HIRISAVE, Bengaluru (IN); Mathew OOMMEN, Plano, TX (US)

(73) Assignee: JIO PLATFORMS LIMITED, Ahmedabad (IN)

(21) Appl. No.: 19/134,274

(22) PCT Filed: Nov. 30, 2023
(86) PCT No.: PCT/IB2023/062067

§ 371 Date: May 30, 2025

(30) Foreign Application Priority Data
Nov. 30, 2022 (IN) 202221068923

(51) Int. Cl. H04W 12/64; H04W 12/06; H04W 60/04

(52) U.S. Cl. CPC H04W 12/64; H04W 12/06; H04W 60/04

(57) ABSTRACT

The present disclosure provides a system (210) and a method for providing a security mechanism to a User Equipment (UE) (204) in a coreless radio access network (RAN). The system (210) receives a registration request from a UE (204), where the registration request includes user subscription data. The system (210) determines if the user subscription data is available within a mobile radio unit for a specific geographic area. Based on a positive determination, the system (210) provides a security mechanism to the UE (204). Based on a negative determination, the system (210) may send a data acquisition request to at least one data source. The system (210) may receive data associated with the specific geographic area from the at least one data source, and provide the security mechanism to the UE (204) based on the received data.

### RESERVATION OF RIGHTS

A portion of the disclosure of this patent document contains material which is subject to intellectual property rights such as, but are not limited to, copyright, design, trademark, IC layout design, and/or trade dress protection, belonging to Jio Platforms Limited (JPL) or its affiliates (herein after referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### TECHNICAL FIELD

The present invention relates to a field of wireless communication, and specifically to a system and a method for providing a security mechanism, for example, a radio access node security mechanism to a User Equipment (UE) to support coreless Radio Access Network (RAN) operation in cellular networks.

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

As known, Fifth Generation (5G) communication technology includes multiple upgraded features than that are available in Fourth-Generation (4G) communication technology. The 5G wireless communication technology, developed in 3rd Generation Partnership Project (3GPP) is meant to deliver higher multi-Gbps peak data speeds, provide ultra-low latency, more reliability and massive network capacity, increased availability, and a more uniform user experience to multiple users. The higher performance and improved efficiency provided by the 5G technology empowers new user experiences and connects new industries. By incorporating use of the 5G technology, some of objectives of the industry have been met but there are still quite a few issues that need to be resolved especially when it comes to accommodating industry verticals, architectures to support private networks, support flexible network deployments, etc.

A 5G core has a fully service based (SBA) architecture with new service-based interfaces (SBIs), and therefore, decouples a service consumer from a producer. The 5G core supports following new capabilities such as improved session management to enable session and service continuity by a “make before break” option which is essential for Ultra-Reliable Low Latency Communications (URLLC) use cases, flow-based Quality Of Service (QoS) framework assuring QoS on an application level, flexible end-to-end and seamless network slicing across RAN, core and transport network with User Equipments (UEs) being able to simultaneously access more than one slice. As is illustrated in FIG. 1, at 100, 5G network nodes include the UEs, Next Generation Node Base station (gNB), a Core Access and Mobility Management Function (AMF) which is responsible for termination of Radio Access Network (RAN) control plane interface, a Non Access Stratum (NAS) for ciphering and integrity protection, mobility management, and access authentication and authorization that acts as a Security Anchor Function (SEA). The AMF also interacts with a Unified Data Management (UDM) and the UE as a part of UE's authentication process. The AMF is responsible for Security Context Management (SCM). Further, User Plane Function (UPF) of core network covers functions of QoS handling, packet routing and forwarding, packet inspection and policy rule enforcement, and traffic accounting and reporting, and acts as an anchor point for Intra-/Inter-Radio access technology (RAT) mobility whenever applicable.

In addition, the architecture includes a Session Management Control Function (SMF) that manages the sessions, the UE Internet Protocol (IP) address allocation and management (including optional authorization), selection and control of user plane function, termination of interfaces towards policy control and charging functions which allows to control part of policy enforcement and QoS. Further, the architecture handles roaming functionality, local enforcement to apply QoS service level agreements (SLAs) (i.e., Visited Public Land Mobile Network (VPLMN)), charging data collection, and charging interface (VPLMN). The provided Data Network (DN) handles operator services, internet access, or other services. Authentication Server Function (AUSF) performs authentication processes with the UE. The UDM supports Authentication Credential Repository and Processing Function (ARPF). The ARPF function stores long-term security credentials used in authentication for AKA and helps in storing of subscription information. A Policy Control Function (PCF) provides support of unified policy framework to govern network behaviour.

In the above explained 5G network architecture, the radio access nodes and core network functions are tightly coupled resulting in multiple shortcomings at functional level. There is, therefore, a need in the art for an improved system and a method to provide a Sixth Generation (6G) network architecture that overcomes various shortcomings and addresses network flexibility issues.

### OBJECTS OF THE PRESENT DISCLOSURE

Some of the objects of the present disclosure, which at least one embodiment herein satisfies are listed herein below.

It is an object of the present disclosure to provide a system and a method for providing a radio access node security mechanism to a User Equipment (UE) to support coreless Radio Access Network (RAN) operation in cellular networks.

It is an object of the present invention to provide a system and a method that allows radio access nodes to operate in a coreless operation mode for authorization/authentication of a user terminal or a UE.

It is an object of the present invention to provide a system and a method to support a coreless RAN functionality to support unmanned aerial vehicle (UAV) based radio access operations in 6^{th} Generation (6G) network technology.

It is an object of the present disclosure to provide a system and a method that facilitates to provide better Quality of Service (QoS) for enhancing end user experience.

It is an object of the present disclosure to provide an enhanced network system with (a) network programmability, (b) deployment flexibility (c) simplicity and efficiency, (d) security, robustness, and reliability; and (e) automation.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure relates to a system for providing a security mechanism to a User Equipment (UE) in a coreless radio access network (RAN). The system includes a processor, and a memory operatively coupled with the processor. The memory stores instructions which, when executed by the processor, cause the processor to receive a registration request from a UE, where the registration request includes user subscription data. The processor determines if the user subscription data is available within a mobile radio unit for a specific geographic area. Based on a positive determination, the processor provides a security mechanism to the UE. Based on a negative determination, the processor sends a data acquisition request to at least one data source. The processor receives data associated with the specific geographic area from the at least one data source, and provide the security mechanism to the UE based on the received data.

In an embodiment, the memory includes processor-executable instructions, which on execution, may cause the processor to update a database based on the received data.

In an embodiment, the registration request may include one or more Non-Access Stratum (NAS) messages.

In an embodiment, the memory includes processor-executable instructions, which on execution, may cause the processor to decode the one or more NAS messages, authenticate the one or more NAS messages upon decoding, select a security mechanism based on the authentication, and provide the security mechanism to the UE.

In an aspect, the present disclosure relates to a method for providing a security mechanism to a User Equipment (UE) in a coreless radio access network (RAN). The method includes receiving, by a processor associated with a system, a registration request from a UE, where the registration request includes user subscription data. The method includes determining, by the processor, if the user subscription data is available within a mobile radio unit for a specific geographic area. Based on a positive determination, the method includes providing, by the processor, a security mechanism to the UE. Based on a negative determination, the method includes sending, by the processor, a data acquisition request to at least one data source. The method includes receiving, by the processor, data associated with the specific geographic area from the at least one data source, and providing, by the processor, the security mechanism to the UE based on the received data.

In an embodiment, the method may include updating, by the processor, a database based on the received data.

In an embodiment, the registration request may include one or more Non-Access Stratum (NAS) messages.

In an embodiment, the method may include decoding, by the processor, the one or more NAS messages, authenticating, by the processor, the one or more NAS messages upon decoding, selecting, by the processor, a security mechanism based on the authentication, and providing the security mechanism to the UE.

In an aspect, the present disclosure relates to a user equipment (UE). The UE includes a processor, and a memory operatively coupled to the processor. The memory includes processor-executable instructions, which on execution, cause the processor to send a registration request to a system. The processor is communicatively coupled with the system, and the system is configured to receive the registration request from the UE, where the registration request includes user subscription data. The system is configured to determine if the user subscription data is available within a mobile radio unit for a specific geographic area. Based on a positive determination, the system is configured to provide a security mechanism to the UE. Based on a negative determination, the system is configured to send a data acquisition request to at least one data source. The system is configured to receive data associated with the specific geographic area from the at least one data source, and provide the security mechanism to the UE based on the received data.

In an aspect, the present disclosure relates to a non-transitory computer-readable medium comprising processor-executable instructions that cause a processor to receive the registration request from the UE, where the registration request includes user subscription data, and determine if the user subscription data is available within a mobile radio unit for a specific geographic area. Based on a positive determination, the processor provides a security mechanism to the UE. Based on a negative determination, the processor sends a data acquisition request to at least one data source, receives data associated with the specific geographic area from the at least one data source, and provide the security mechanism to the UE based on the received data.

### BRIEF DESCRIPTION OF DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure. The diagrams are for illustration only, which thus is not a limitation of the present disclosure.

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates a block diagram of a 5^{th} Generation (5G) core network architecture.

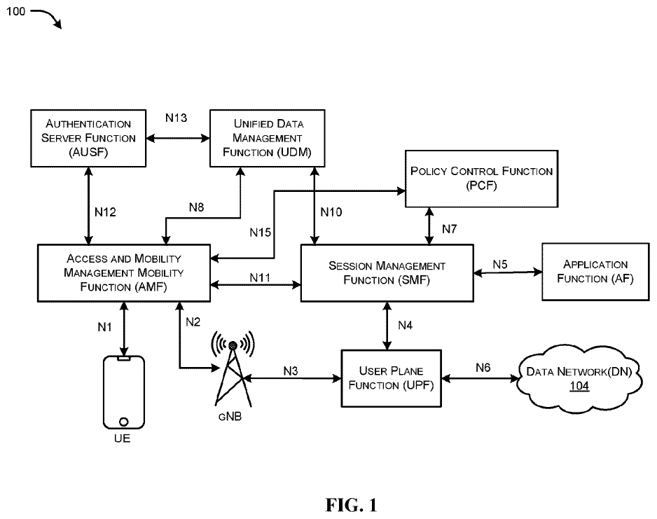

FIG. 2A illustrates an exemplary network architecture for implementing a proposed system, in accordance with an embodiment of the present disclosure.

FIG. 2B illustrates an example block diagram of a proposed system, in accordance with an embodiment of the present disclosure.

FIG. 3 illustrates an exemplary architecture for implementing a coreless Radio Access Network (RAN) security mechanism, in accordance with an embodiment of the present disclosure.

FIG. 4 illustrates a sequential flow diagram for updating a Local Data Management (LDM) entity with relevant user subscription information, in accordance with an embodiment of the present disclosure.

FIG. 5 illustrates an exemplary architecture for implementing a coreless RAN security mechanism, in accordance with another embodiment of the present disclosure.

FIG. 6 illustrates a sequential flow diagram for authentication of a User Equipment (UE) by a LDM, in accordance with an embodiment of the present disclosure.

FIG. 7 illustrates an exemplary computer system in which or with which embodiments of the present invention can be utilized in accordance with embodiments of the present disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive in a manner similar to the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

6^{th} Generation (6G) networks are expected to provide radio and access architecture for both communications and sensing purposes, such as, for Artificial Intelligence (AI) optimized wide area network and data centre co-design, and for dynamic orchestration of personalized services to revolutionize long tail of niche consumer interests. While demand for mobile broadband is expected to continuously increase for consumers and enterprise alike, uptake of ultra-reliable and low latency may be largely driven by specialized and local use cases in conjunction with non-public networks, and often with augmented intelligence. This may happen as an integral part of automated and secure network transformation where it is expected that objects ranging from cars, industrial machines, and appliances to watches and apparel, may learn and organize themselves to fulfil requirements by automatically adapting to user behaviour, environment and business processes.

In addition, achieving energy efficiency is another key design criterion for the design of 6G, since performance of the network may depend on energy available in respective architectural domains. With respect to achieving energy efficiency, one of the most challenging requirements arises from use of remote control of devices in conjunction with augmented reality and involving immersive media experience. In these cases, in addition to Extreme Ultra-Reliable Low Latency (URLLC) performance requirement, there is a demand for ultra-high rates of 100 Gbit/s or higher resulting in allowing uncompressed transmission of high quality 360-degree video. This eventually results in requirement of a degree of flexibility and specialization beyond 5^{th} Generation (5G) network capabilities.

Thus, it is appropriate to assume that design of the 6G networks may be open service driven and, in short, business needs may drive 6G product and service creation. The 6G networks may be an integral part of the automated Exchange to Exchange (E2E) service workflow that is steered and guided by policy and intent. In other words, use case driven means may be provided to meet diverse needs and preferences of each of a user, whether it is a human, a physical machine, or a digital twin. To summarise, key requirements for designing of the 6G architecture includes providing (a) network programmability; (b) deployment flexibility; (c) simplicity and efficiency; (d) security, robustness, and reliability; and (e) automation.

For future technological advancements, a new paradigm of wireless communication technology i.e., a 6G system is proposed that provides a comprehensive support to Artificial Intelligence (AI) supporting devices. The 6G system provides improved services as compared to the existing 5G system and resolves some fundamental issues by providing higher system capacity, higher data rate, lower latency, and improved quality of service (QoS). In addition, the proposed 6G architecture facilitates to resolve an issue of addressing coreless mode of radio access network (RAN) operation.

As may be appreciated, one of key requirements for 6G cellular network radio base stations which is expected to support mobility access nodes such as access nodes on UAVs is a coreless network concept, where the RAN node works independent of the core network. To support such independent RANs that works independent of the core networks, an existing security architecture needs to be reworked as a current security mechanism available for User Equipments (UEs) is split across access and core network entities and has multiple shortcomings. The present disclosure proposes a system and a method to provide an architecture having a two-tier security mechanism at the RAN itself.

The proposed disclosure provides a system and a method to address an issue of decoupling the RAN access nodes from the core networks where the device authentication/authorization becomes independent of the core network. The system supports a coreless RAN functionality which supports Un-crewed/Unmanned Aerial Vehicles (UAV) based radio access operations and be used in 6G network architecture as a fundamental building block.

In the proposed embodiments, a core independent radio access node is equipped to authenticate and authorize a device. Further, dependency of the radio access node with the core network is only for duration of downloading subscription profile from a core network user subscription entity.

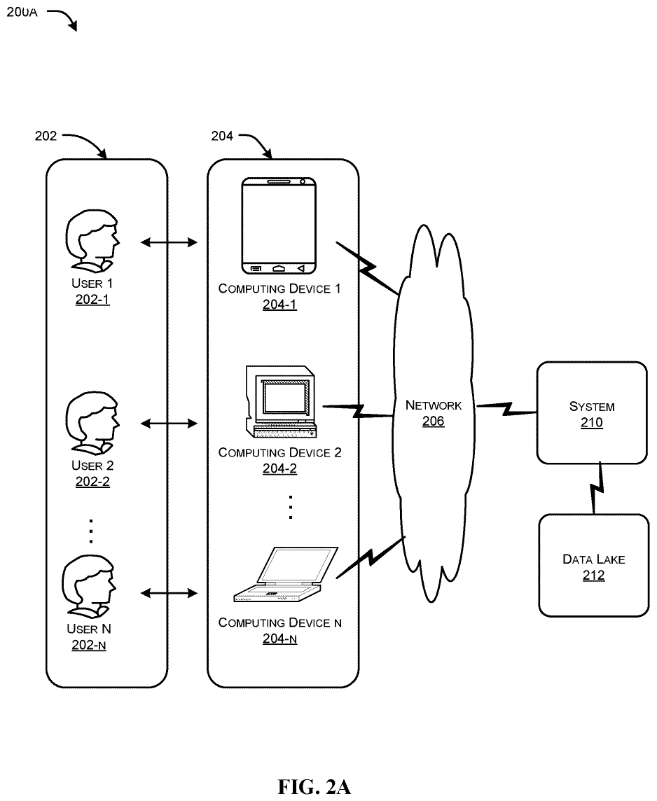

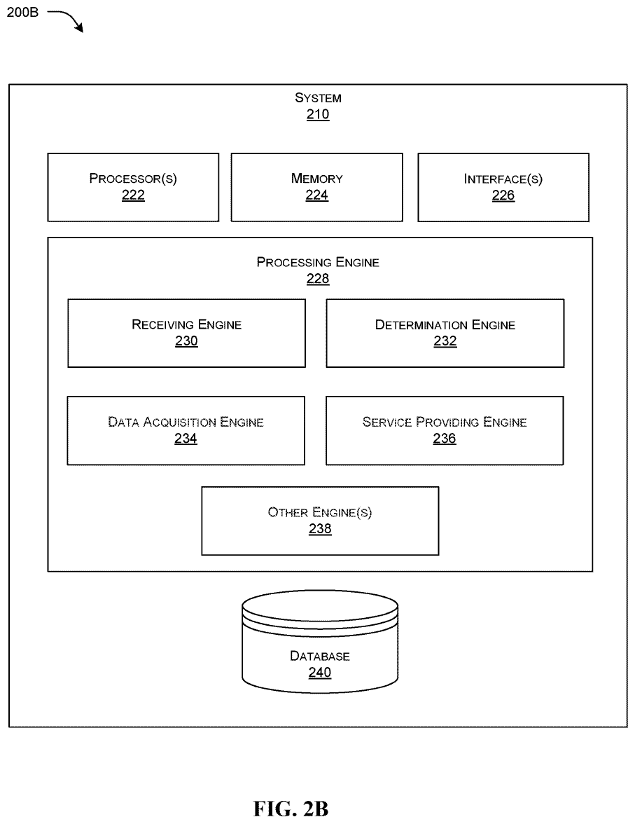

The various embodiments throughout the disclosure will be explained in more detail with reference to FIGS. 2A-7.

FIG. 2A illustrates an exemplary network architecture (200A) for implementing a proposed system (210), in accordance with an embodiment of the present disclosure.

With reference to FIG. 2A, the network architecture (200A) may include a system (210). The system (210) may be connected to one or more computing devices (204-1, 204-2 . . . 204-N) via a network (206). The one or more computing devices (204-1, 204-2 . . . 204-N) may be interchangeably specified as a user equipment (UE) (204) and be operated by one or more users (202-1, 202-2 . . . 202-N). Further, the one or more users (202-1, 202-2 . . . 202-N) may be interchangeably referred as a user (202) or users (202). The system (210) may include or be associated with a data lake (212) including a plurality of data sources. The plurality of data sources may include, but not limited to, a Local Data Management (LDM) entity, a Light weight Access and Mobility Management Function (AMF) entity, Unified Data Management (UDM) entity, a Home Subscriber Server (HSS) entity, and the like.

In an embodiment, the computing devices (204) may include, but not be limited to, a mobile, a laptop, etc. Further, the computing devices (204) may include a smartphone, virtual reality (VR) devices, augmented reality (AR) devices, a general-purpose computer, a desktop, a personal digital assistant, a tablet computer, and a mainframe computer. Additionally, input devices for receiving input from the user (202) such as a touchpad, touch-enabled screen, electronic pen, and the like may be used. A person of ordinary skill in the art will appreciate that the computing devices (204) may not be restricted to the mentioned devices and various other devices may be used. The computing devices (204) may be referred to as a User Equipment (UE).

In an embodiment, the network (206) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The network (206) may also include, by way of example but not limitation, one or more of a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof. The network (206) may include, by way of example but not limitation, a unicast network, a multicast network, or a broadcast network.

In an embodiment, the system (210) may receive a registration request from a UE (204). The registration request may include user subscription data. The system (210) may determine if the user subscription data is available within a mobile radio unit for a specific geographic area. If the user subscription data is available within the mobile radio unit for the specific geographic area, the system (210) may provide a security mechanism to the UE. If the user subscription data is not available within the mobile radio unit for the specific geographic area, the system (210) may send a data acquisition request to at least one data source, for example, the UDM entity. The system (210) may receive data associated with the specific geographic area from the at least one data source, and provide the security mechanism to the UE (204) based on the received data.

Although FIG. 2A shows exemplary components of the network architecture (200A), in other embodiments, the network architecture (200A) may include fewer components, different components, differently arranged components, or additional functional components than depicted in FIG. 2. Additionally, or alternatively, one or more components of the network architecture (200A) may perform functions described as being performed by one or more other components of the network architecture (200A).

FIG. 2B illustrates an example block diagram of a proposed system (210), in accordance with an embodiment of the present disclosure.

With reference to FIG. 2B, the system (210) may comprise one or more processor(s) (222) that may be implemented as one or more microprocessors, microcomputers, microcontrollers, digital signal processors, central processing units, logic circuitries, and/or any devices that process data based on operational instructions. Among other capabilities, the one or more processor(s) (222) may be configured to fetch and execute computer-readable instructions stored in a memory (224) of the system (210). The memory (224) may be configured to store one or more computer-readable instructions or routines in a non-transitory computer-readable storage medium, which may be fetched and executed to create or share data packets over a network service. The memory (224) may comprise any non-transitory storage device including, for example, volatile memory such as random-access memory (RAM), or non-volatile memory such as erasable programmable read-only memory (EPROM), flash memory, and the like.

In an embodiment, the system (210) may include an interface(s) (226). The interface(s) (226) may include a variety of interfaces, for example, interfaces for data input and output (I/O) devices, storage devices, and the like. The interface(s) (226) may also provide a communication pathway for one or more components of the system (210). Examples of such components include, but are not limited to, processing engine(s) (228) and a database (240), where the processing engine(s) (228) may include, but not be limited to, a receiving engine (230), a determination engine (232), a data acquisition engine (234), a service providing engine (236), and other engine(s) (238). The other engine(s) (238) may include, but not limited to, a monitoring engine, and the like.

In an embodiment, the processing engine(s) (228) may be implemented as a combination of hardware and programming (for example, programmable instructions) to implement one or more functionalities of the processing engine(s) (228). In examples described herein, such combinations of hardware and programming may be implemented in several different ways. For example, the programming for the processing engine(s) (228) may be processor-executable instructions stored on a non-transitory machine-readable storage medium and the hardware for the processing engine(s) (228) may comprise a processing resource (for example, one or more processors), to execute such instructions. In the present examples, the machine-readable storage medium may store instructions that, when executed by the processing resource, implement the processing engine(s) (228). In such examples, the system (210) may comprise the machine-readable storage medium storing the instructions and the processing resource to execute the instructions, or the machine-readable storage medium may be separate but accessible to the system (210) and the processing resource. In other examples, the processing engine(s) (228) may be implemented by electronic circuitry.

In an embodiment, the processor (222), via the receiving engine (230), may receive a registration request from a UE (204). The registration request may include user subscription data.

In an embodiment, the processor (222), via the determination engine (232), may determine if the user subscription data is available within a mobile radio unit for a specific geographic area.

In an embodiment, based on a positive determination, the processor (222), via the service providing engine (236), may provide a security mechanism to the UE (204).

In an embodiment, based on a negative determination, the processor (222), via the data acquisition engine (234), may send a data acquisition request to at least one data source, for example, the UDM entity. The processor (222), via the data acquisition engine (234), may receive data associated with the specific geographic area from the at least one data source. Further, the processor (222), via the service providing engine (236), may provide the security mechanism to the UE (204) based on the received data.

Although FIG. 2B shows exemplary components of the system (210), in other embodiments, the system (210) may include fewer components, different components, differently arranged components, or additional functional components than depicted in FIG. 2B. Additionally, or alternatively, one or more components of the system (210) may perform functions described as being performed by one or more other components of the system (210).

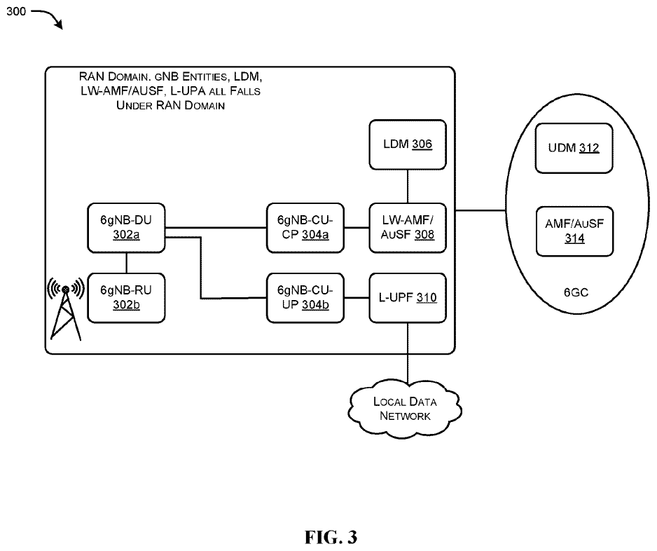

FIG. 3 illustrates an exemplary architecture (300) for implementing a coreless RAN security mechanism, in accordance with an embodiment of the present disclosure.

With reference to FIG. 3, the architecture (300) may include a 6gNodeB (6gNB)-Distribution Unit (DU) (302a) and a 6gNB-Radio Unit (RU) (302b). The architecture (300) may support local authentication at a radio access network node itself. An entity called as a LDM entity (306) or LDM function may be introduced in the radio access node. The LDM entity (306) may store user subscription data related to a geography of an operation of a mobile radio unit (i.e., a base station on a UAV).

An additional entity which emulates the core network security function may be termed as a Light weight AMF entity or function (LW-AMF/AuSF) (308). The LW-AMF/AuSF (308) may be introduced in a RAN domain to perform functions such as registration request including authentication and security for the UEs (204) or the users (202) supported by the LDM (306).

In another embodiment, both the LDM entity (306) and the LW-AMF/AuSF entity (308) present in the RAN domain may be realized as application functions in Central Unit Control Plane (CU-CP) (304a, 304b) of the radio access node. The CU-CP (304a, 304b) of the radio access node may be in connection with the 6gNB-DU (302a) and the 6gNB-RU (302b). The CU-CP (304a, 304b) may establish a connection with the LW-AMF/AuSF (308) and a User Plane Function (UPF) (310).

In some embodiments, the architecture (300) may include a 6G core network associated with a UDM entity (312) and an AMF/AuSF entity (314) to receive user subscription data of interest.

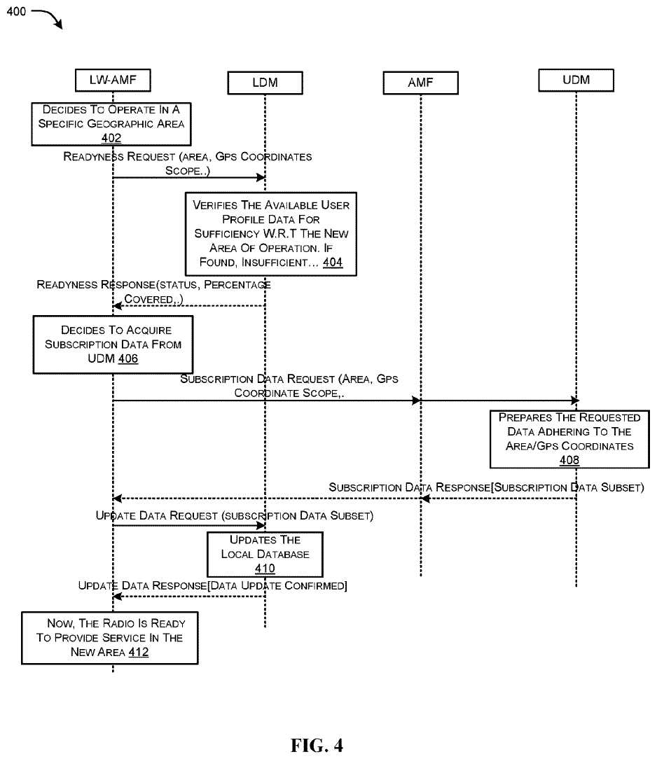

FIG. 4 illustrates a sequential flow diagram (400) for updating a LDM entity with relevant user subscription information, in accordance with an embodiment of the present disclosure.

With reference to FIG. 4, the user subscription data may be applicable for a “Mobile Radio Unit or entity”. In an embodiment, a mechanism may be provided where the LDM and the LW-AMF checks if for a given geographic area of mobility of the mobile radio unit operation, the user subscription data is available within the mobile radio unit. If not, the LDM/LW-AMF may query a core network UDM entity or any entity that has a complete user subscription data, such as, a Home Subscriber Server (HSS) entity to download user profile information of interest. This may be a first step before any authorization and authentication is carried out for any user equipment by the mobile radio entity.

Downloading of the user subscription data from the UDM or the HSS entity by the mobile radio unit may occur before the mobile radio unit begins its mobility trajectory or during the flight/mobility trajectory through a secure connection via a satellite or any other available connectivity mechanism.

As is illustrated, at 402, when the LW-AMF decides to operate in a specific geographic area, the LW-AMF may send a readiness request to the LDM. At 404, the LDM may verify the available user profile data for sufficiency with respect to a new area of operation. The LDM may then send a reediness response to the LW-AMF. At 406, the LW-AMF may then decide to acquire subscription data from the UDM. For this, the LW-AMF may send a subscription data request to the UDM. At 408, the UDM may prepare the requested data adhering to the area/Global Positioning System (GPS) co-ordinates via a subscription data response to the LW-AMF. At 410, the LW-AMF may send an update data request to the LDM so that a local database may be updated and an update data response may be sent to the LW-AMF. At 412, the LW-AMF may provide a signal that the system (210) is ready to provide service in the new area of operation.

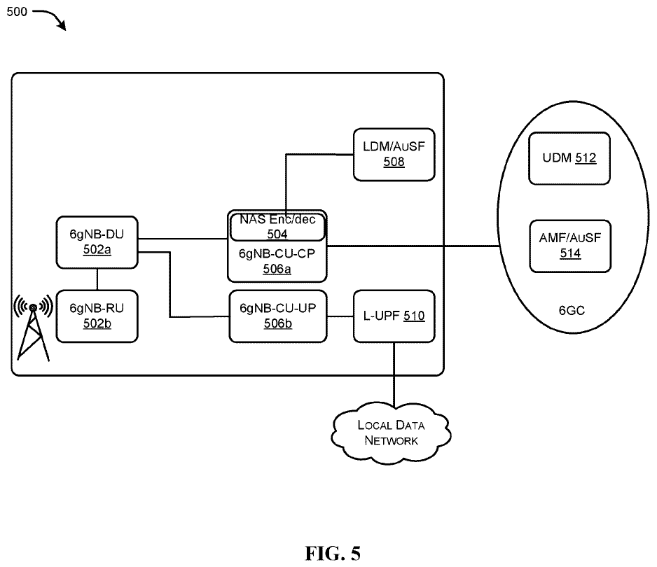

FIG. 5 illustrates an exemplary architecture for implementing a coreless RAN security mechanism, in accordance with another embodiment of the present disclosure.

With reference to FIG. 5, to support an independent RAN security mechanism, another variation of the architecture is proposed, where a Central Unit-Control Plane (CU-CP) (506a) may itself decode Non Access Stratum (NAS) messages as a replacement to a LW-AMF entity as described in FIG. 3, and authenticate the user (202) at the radio access node/mobility radio unit entity itself. The CU-CP (506a) may support NAS encoder and decoder functions (504), and hence the NAS messages may get decoded within the CU-CP (506a) and relevant actions may be initiated for specific service types.

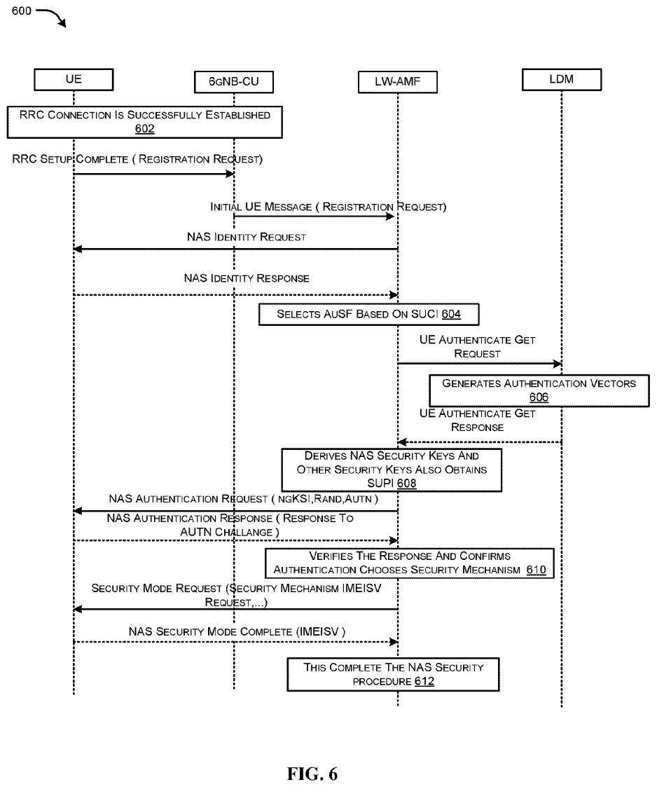

FIG. 6 illustrates a sequential flow diagram (600) for authentication of a UE (204) by a LDM, in accordance with an embodiment of the present disclosure.

With reference to FIG. 6, for all other service types during non-mobility mode, the CU-CP entity in the mobile unit may forward the NAS messages to 6GC for further processing. When the RAN entity is in a flight/mobility mode where the core network connectivity is not available, the CU-CP itself may act as a proxy core network by processing the NAS messages.

With respect to the disclosed sequence flow, at 602, when a Radio Resource Control (RRC) connection is successfully established at the UE (204) and 6GNB-CU, the UE (204) may send a RRC setup complete (registration request) to 6gNB-CU. The 6GNB-CU may send an initial UE message (registration request) to the LW-AMF. The LW-AMF may send a NAS identity request to the UE (204) and subsequently receive a NAS identity response from the UE (204). At 604, the LW-AMF may select an Authentication Server Function (AUSF) based on Subscription Concealed Identifier (SUCI) and send a UE authenticate get request to an LDM. At 606, the LDM may thus generate authentication vectors and send a UE authenticate get response to the LW-AMF. At 608, the LW-AMF may derive NAS security keys and other security keys. In addition, the LW-AMF may obtain Subscription Permanent Identifier (SUPI) and send a NAS authentication request (NGKSI, RAND, AUTH) to the UE (204). The UE (204) may then send a NAS authentication response (response to AUTH challenge) to the LW-AMF. At 610, the LW-AMF may verify the response and confirm authentication. The LW-AMF may choose security mechanism and send a security mode request (Security Algorithm, IMEISV request) to the UE (204). At 612, the UE may send a NAS security mode complete (IMEISV) message to the LW-AMF, thus completing the NAS security procedure.

In an embodiment the RAN node and a core network may be connected via a satellite.

In yet another embodiment, the connectivity between the RAN node and the core entity may be short lived with intermittent connectivity. Therefore, a signalling mechanism may be described between the RAN node and the core entity where the core network may download a predefined or an “on demand” set of subscriber information to the LW-AMF and the AuSF entities from the HSS in the core network before the connectivity between the RAN node and a core network is terminated.

To facilitate a local data caching, a Packet Gateway (PGW) cache may be provided in the independent RAN node that may establish a data path between the UE (204) and the RAN node. Thereafter, the data may be collected from the RAN node. The inter RAN node communication may be established when the data path requested may be for another UE that is within vicinity of call initiating device.

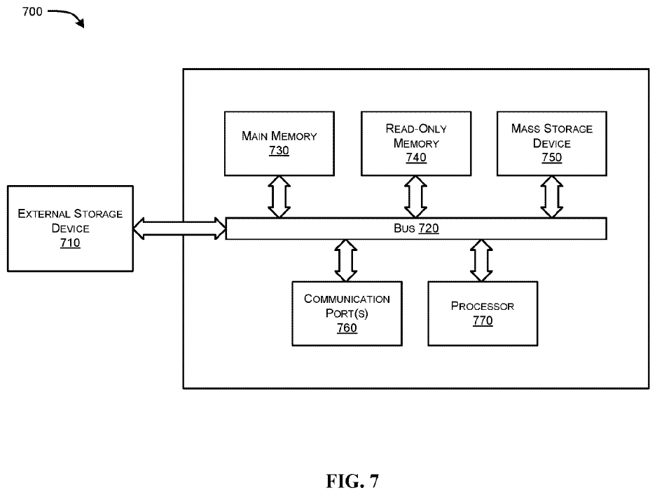

FIG. 7 illustrates an exemplary computer system (700) in which or with which embodiments of the present invention can be utilized in accordance with embodiments of the present disclosure.

As shown in FIG. 7, computer system (700) may include an external storage device (710), a bus (720), a main memory (730), a read only memory (740), a mass storage device (750), a communication port (760), and a processor (770). A person skilled in the art will appreciate that the computer system (700) may include more than one processor and communication ports. Processor (770) may include various modules associated with embodiments of the present invention. Communication port (760) may be any of an RS-232 port for use with a modem based dialup connection, a 10/100 Ethernet port, a Gigabit or 10 Gigabit port using copper or fiber, a serial port, a parallel port, or other existing or future ports. Communication port (760) may be chosen depending on a network, such a Local Area Network (LAN), Wide Area Network (WAN), or any network to which computer system connects. Memory (730) may be a Random Access Memory (RAM), or any other dynamic storage device commonly known in the art. Read-only memory (740) may be any static storage device(s) e.g., but not limited to, a Programmable Read Only Memory (PROM) chips for storing static information e.g., start-up or BIOS instructions for the processor (770). Mass storage (750) may be any current or future mass storage solution, which may be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), one or more optical discs, Redundant Array of Independent Disks (RAID) storage, e.g. an array of disks.

Bus (720) communicatively couples the processor(s) (770) with the other memory, storage and communication blocks. Bus (720) may be, e.g., a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects the processor (770) to a software system.

Optionally, operator and administrative interfaces, e.g., a display, keyboard, joystick and a cursor control device, may also be coupled to the bus (720) to support direct operator interaction with the computer system (700). Other operator and administrative interfaces may be provided through network connections connected through the communication port (760). Components described above are meant only to exemplify various possibilities. In no way should the aforementioned exemplary computer system (700) limit the scope of the present disclosure.

Various embodiments of the present disclosure enable the system (210) to decouple access nodes of the RAN from the core network so as to enable independent authentication/authorization of the UE (204) that is a part of the core network. This decoupling may support coreless RAN functionality which in turn better supports mobile access systems such as UAV based radio access nodes and may be used in 6G network architecture as a fundamental building block.

Moreover, in interpreting the specification, all terms should be interpreted in the broadest possible manner consistent with context. In particular, the term “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C, . . . and N, the text should be interpreted as requiring only one element from the group, not A plus N, or B plus N, etc.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

### Advantages of the Present Disclosure

The present disclosure provides a system and a method where radio access nodes may operate in a coreless operation mode for authorization/authentication of a User Equipment (UE) or a user terminal.

The present disclosure provides a system and a method to support a coreless RAN functionality to support unmanned aerial vehicle (UAV) based radio access operations in 6G network technology.

The present disclosure provides a system and a method to facilitate better Quality of Service (QoS) for enhancing end user experience.

The present disclosure provides an enhanced network system with (a) network programmability; (b) deployment flexibility; (c) simplicity and efficiency; (d) security, robustness, and reliability; and (e) automation.

We claim:

1. A system (210) for providing a security mechanism to a User Equipment (UE) (204) in a coreless radio access network (RAN), the system (210) comprising:
a processor (222); and
a memory (224) operatively coupled with the processor (222), wherein said memory (224) stores instructions which, when executed by the processor (222), cause the processor (222) to:
receive a registration request from a UE (204), wherein the registration request comprises user subscription data;
determine if the user subscription data is available within a mobile radio unit for a specific geographic area;
based on a positive determination, provide a security mechanism to the UE (204);
based on a negative determination, send a data acquisition request to at least one data source;
receive data associated with the specific geographic area from the at least one data source; and
provide the security mechanism to the UE (204) based on the received data.

2. The system (210) as claimed in claim 1, wherein the memory (224) comprises processor-executable instructions, which on execution, cause the processor (222) to update a database (240) based on the received data.

3. The system (210) as claimed in claim 1, wherein the registration request comprises one or more Non-Access Stratum (NAS) messages.

4. The system (210) as claimed in claim 3, wherein the memory (224) comprises processor-executable instructions, which on execution, cause the processor (222) to:
decode the one or more NAS messages;
authenticate the one or more NAS messages upon decoding;
select a security mechanism based on the authentication; and
provide the security mechanism to the UE (204).

5. A method for providing a security mechanism to a User Equipment (UE) (204) in a coreless radio access network (RAN), the method comprising:
receiving, by a processor (222) associated with a system (210), a registration request from a UE (204), wherein the registration request comprises user subscription data;
determining, by the processor (222), if the user subscription data is available within a mobile radio unit for a specific geographic area;
based on a positive determination, providing, by the processor (222), a security mechanism to the UE (204);
based on a negative determination, sending, by the processor (222), a data acquisition request to at least one data source;
receiving, by the processor (222), data associated with the specific geographic area from the at least one data source; and
providing, by the processor (222), the security mechanism to the UE (204) based on the received data.

6. The method as claimed in claim 5, comprising updating, by the processor (222), a database (240) based on the received data.

7. The method as claimed in claim 5, wherein the registration request comprises one or more Non-Access Stratum (NAS) messages.

8. The method as claimed in claim 7, comprising:
decoding, by the processor (222), the one or more NAS messages;
authenticating, by the processor (222), the one or more NAS messages upon decoding;
selecting, by the processor (222), a security mechanism based on the authentication; and
providing, by the processor (222), the security mechanism to the UE (204).

9. A user equipment (UE) (204), comprising:
a processor; and
a memory operatively coupled to the processor, wherein the memory comprises processor-executable instructions, which on execution, cause the processor to:
send a registration request to a system (210);
wherein the processor is communicatively coupled with the system (210), and wherein the system (210) is configured to:
receive the registration request from the UE (204), wherein the registration request comprises user subscription data;
determine if the user subscription data is available within a mobile radio unit for a specific geographic area;
based on a positive determination, provide a security mechanism to the UE (204);
based on a negative determination, send a data acquisition request to at least one data source;
receive data associated with the specific geographic area from the at least one data source; and
provide the security mechanism to the UE (204) based on the received data.

10. A non-transitory computer-readable medium comprising processor-executable instructions that cause a processor to:
receive the registration request from a UE (204), wherein the registration request comprises user subscription data;
determine if the user subscription data is available within a mobile radio unit for a specific geographic area;
based on a positive determination, provide a security mechanism to the UE (204);
based on a negative determination, send a data acquisition request to at least one data source;
receive data associated with the specific geographic area from the at least one data source; and
provide the security mechanism to the UE (204) based on the received data.
